(19) United States
(12) Patent Application Publication
(10) Pub. No.: US 2009/0022462 A1
(43) Pub. Date: Jan. 22, 2009

(54) FIRE RESISTANT JACKET COMPOSITION FOR ELECTRICAL COAXIAL AND FIBER OPTIC CABLE

(75) Inventors: Elisabeth S. PAPAZOGLOU, Yardley, PA (US); Don Gary BARBER, Westchester, PA (US)

Correspondence Address: RATNERPRESTIA, P.O. BOX 1596, WILMINGTON, DE, 19899, US

(73) Assignee: POLYMER PRODUCTS COMPANY, INC., Mount Laurel, NJ (US)

(21) Appl. No.: 12/176,849

(22) Filed: Jul. 21, 2008

Related U.S. Application Data
(60) Provisional application No. 61/058,289, filed on Jun. 3, 2008.
(60) Provisional application No. 60/961,380, filed on Jul. 20, 2007.

(51) Int. Cl. G02B 6/02; H01B 3/46; C08K 3/34; C08K 5/09; C08K 5/51

(52) U.S. Cl. 385/123; 174/110 S; 524/450; 524/319; 524/151

(57) ABSTRACT

Zeolite-containing polyvinyl chloride containing compositions that are useful as the insulation for plenum cables are disclosed. A zeolite, either natural or synthetic, can satisfactorily replace either part or all of the molybdenum compound, particularly ammonium octamolybdate, in low smoke polyvinyl chloride based plenum compositions. Ion-exchanged zeolites, such as the zinc ion-exchanged zeolite can also be used. Zeolites are especially useful in lead-free Low Smoke PVC compositions. Because the cost of zeolite is only a fraction of the cost of the molybdenum compounds currently used in plenum cable compositions, this will dramatically reduce the cost of these materials.

### CROSS REFERENCE TO RELATED APPLICATIONS

This patent application claims priority benefit of U.S. Provisional Appln. Nos. 60/961,380, filed Jul. 20, 2007, and 61/058,289, filed Jun. 3, 2008, both of which are incorporated herein in their entirety by reference.

### FIELD OF THE INVENTION

This invention relates to fire resistant compositions for plenum cable insulation. In particular, this invention relates to zeolite-containing polyvinyl chloride containing compositions that are useful as the insulation for plenum cables.

### BACKGROUND OF THE INVENTION

The plenum generally consists of the horizontal space between the structural roof and the suspended ceiling of a building or the space under a raised floor. In the National Electrical Code of 1999, a plenum is defined as “a compartment or chamber to which one or more air ducts are connected and that forms part of the air distribution system”. These spaces are used for air circulation in heating and air conditioning systems. Cables, known as plenum cables, are placed in the plenum for a wide variety of uses, such as data transmission and voice communications.

Plenums are continuous throughout a floor of a building. If a fire reaches the plenum, and especially if flammable material is present in the plenum, the fire can spread quickly throughout the entire floor of the building. The fire can travel along the plenum cables if the cables are not resistant to fire. Smoke can also be conveyed through the plenum to adjacent areas and to other floors with the possibility of smoke permeation throughout the entire building. To prevent the spread of smoke and flame throughout the building via the plenum, the insulation material for the cables must meet stringent flame and smoke requirements. In addition, to prevent wire-to-wire electrical interactions from disrupting the integrity and reliability of communication signals, the insulation material must have a high dielectric constant.

Because of this possibility of flame spread and smoke evolution, cables in plenums are required to have low flame spread and smoke generating characteristics. The flame spread and smoke production of cables are measured using the UL-910, also known as the “Steiner Tunnel Test.” This test is described in an Underwriters Laboratories publication titled “Test Method for Fire and Smoke Characteristics of Cables.” In general, the test is conducted with a single layer of cable 7.3 M (24 ft) long on a 0.5 M (20 in) wide rack placed in a combustion chamber and subjected to a 90 kW (300,000 BTU/hr) methane flame with 73 M/min (240 ft/min) draft exposed for 20 minutes. To pass this test, flame spread must not exceed 5.0 feet after the initial 4.5 foot flame source; smoke generation must not exceed a peak optical density of 0.5 (33% light transmission); and the average optical density must not exceed 0.15 (70% light transmission). Flame spread is a measure of flammability, and optical density is a measure of smoke generation. If optical density due to smoke exceeds 0.5, visibility is impaired and escape becomes difficult. The PVC containing compositions that meet these requirements are referred to as Low Smoke PVC compounds (LS PVC).

Polyvinyl chloride (PVC) is widely used for wire insulation and cable sheathing. Unmodified PVC has relatively good flame retardant properties due to its high chloride content (56.7 wt %). Other desirable attributes of PVC include mechanical toughness, resistance to chemical corrosion, good dielectric properties, and relatively low cost. However, PVC is a rigid thermoplastic that lacks flexibility. PVC is also highly viscous at processing temperatures, and is therefore difficult to compound and process. Consequently, plasticizers are added to PVC to improve the processing characteristics and the flexibility of the end product. However, plasticizers increase the flammability of PVC.

The flammability and smoke generation of PVC can be reduced by adding flame retardant and smoke suppressing materials, the choice of which depends upon the exact composition used. However, it is difficult to achieve both flame retardance and smoke suppression. Compounds that retard flame typically cause incomplete combustion, thus increasing smoke, while smoke suppressants can create higher heats of combustion to more efficiency consume combustible organic gases. Antimony trioxide, for example, acts as a flame retardant, but increases smoke. Therefore, complex mixtures of compounds, some of which retard flame and some of which suppress smoke, are required. Among the materials used as flame retardants in LS PVC based compositions are: metal hydroxides such as hydrated aluminum oxide (alumina trihydrate, Al₂O₃.3H₂O) and magnesium hydroxide (Mg(OH)₂); antimony compounds such as antimony trioxide; and conventional halogenated organic flame retardant compounds.

In a system filled with high levels of flame retardants, synergists, and smoke suppressant there can be a range of interactions both synergistic and antagonistic, making it is difficult to predict how the same chemicals will behave when additives are combined with PVC. One additive that promotes flame retardation or smoke suppression by one mechanism can be counteracted by another that acts by a different mechanism. In spite of a significant amount of work that has been done to understand the mode of operations of different flame retardants and smoke suppressants in simple systems, these studies provide little guidance as to how a complex system will work. There is no reason to believe that an additive that acts favorably in one composition will act favorably in a different composition. Consequently, flammability and smoke tests are performed on the entire composition and not on its individual components. The search for effective flame retardant and/or smoke suppressant additives for a complex system like a plenum cable remains unpredictable.

Smoke suppressants such as zinc borate, zinc stannate and zinc oxide are not, by themselves in PVC, sufficient for passing the UL-910 test. Expensive specialty additives must be used to suppress smoke evolution and pass the UL-910 test. Preferred additives include ammonium octamolybdate (AOM), molybdenum trioxide and other molybdenum compounds. Although ammonium octamolybdate is an expensive material, attempts to replace it with other cheaper materials have generally not been practical. Consequently, a need exists for a cost effective alternative to either totally replace or significantly reduce the amount of ammonium octamolybdate in LS PVC compositions.

### SUMMARY OF THE INVENTION

It has been discovered that zeolites and ion-exchanged zeolites are surprisingly effective in replacing or reducing some of the smoke suppressant and flame retardant additives in compositions that contain polyvinyl chloride and/or other chlorinated polymers. Thus, in one aspect, the invention is a composition useful for wire insulation and cable sheathing of plenum cables, the composition comprising greater than 2 phr, typically about 5 phr or more, more typically about 5 to about 35 phr, about 8 phr to about 30 phr, or about 10 phr to about 25 phr, of a zeolite or a mixture of zeolites, in which the composition passes UL-910 and/or the composition has a limiting oxygen index of 43 or higher and a smoke value of less than 300 m²/Kg in a cone calorimeter test. Some or all of the zeolite can be an ion-exchanged zeolite containing a metal cation, such as zinc or iron.

In another aspect, the invention is a composition comprising:

(a) 100 parts of a base polymer selected from the group consisting of polyvinyl chloride and mixtures of polyvinyl chloride and chlorinated polyvinyl chloride in which the chlorinated polyvinyl chloride comprises 25 wt % of less of the mixture of the polyvinyl chloride and the chlorinated polyvinyl chloride;

(b) 20 to 60 parts of a plasticizer, a brominated phthalate, a phosphate plasticizer, or a mixture thereof;

(c) 2 to 20 parts of a thermal stabilizer or a mixture of thermal stabilizers;

(d) 10 to 100 parts of a metal hydroxide or mixture of metal hydroxides;

(e) 0 to 20 parts of a molybdenum compound or a mixture of molybdenum compounds;

(f) 5 to 35 parts of a zeolite or mixture of zeolites, an ion-exchanged zeolite or a mixture of ion-exchanged zeolites, or a mixture thereof;

wherein:

the composition has a limiting oxygen index of 43 or higher,

the composition has a smoke value of less than 300 m²/Kg in the a calorimeter test, and

at least part of the cations in the ion-exchanged zeolite contain an element selected from the group consisting of Al, V, Mo, Mn, Fe, Co, Ni, Cu, Sn, Zn, Cr, Ti, Zr, W, Sb, Bi, B and P.

In another aspect, the invention is a plenum cable comprising a jacket of the composition enclosing either (a) at least one twisted pair of insulated copper wires or (b) at least one fiber optic cable. In another aspect the invention is a coaxial cable construction with a jacketing comprising the composition. In yet another aspect, the invention is a method for the preparation of sheathings and jackets for electrical and fiber optic cables using the composition of the invention, and a method of manufacturing the electrical and fiber optic cables. In yet another aspect, the invention is an additive package or a master batch comprising the composition of the invention.

### DETAILED DESCRIPTION OF THE INVENTION

Unless otherwise indicated, in the specification and claims, the amount of additive in a composition or a formulation is given in parts per hundred (phr), that is, parts of additive per one hundred parts of base polymer. The base polymer is polyvinyl chloride or, if a mixture of polyvinyl chloride and one or more other chlorine containing polymers is present, the base polymer is the mixture of the polyvinyl chloride and the one or more other chlorine containing polymers.

Unless the context indicates otherwise, in the specification and claims the terms zeolite, ion-exchanged zeolite, plasticizer, phosphate plasticizer, brominated phthalate, stabilizer, filler, thermal stabilizer, flame retardant, brominated flame retardant, smoke suppressant, hydrated metal oxide, lubricant, and similar terms also include mixtures of such materials. The terms filler, flame retardant, and smoke suppressant do not include zeolites or ion-exchanged zeolites. Unless otherwise specified, all percentages are percentages by weight and all temperatures are in degrees Centigrade (degrees Celsius).

In one aspect, the invention is a low flame, low smoke composition suitable for use in the cable jacket of plenum cables. The composition comprises polyvinyl chloride; one or more zeolites and/or ion-exchanged zeolites; one or more plasticizers; one or more stabilizers; and one or more hydrated metal oxides. Additional components, such as molybdenum compounds, antimony compounds, antioxidants, lubricants, acid scavengers, fillers, and colorants can also be present.

The composition has a limiting oxygen index of 41 or higher, 42 or higher, 43 or higher, and, in some cases 44 or higher, 45 or higher, or 46 or higher, or 47 or higher. The composition has a smoke value of less than 350 m²/Kg, less than 300 m²/Kg, and, in some cases less than 275 m²/Kg, or less than 250 m²/Kg, or less than 210 m²/Kg, or less than 200 m²/Kg, in a cone calorimeter test. These values correlate well with the properties necessary for a composition to pass the UL-910 and similar test, such as ASTM E84, and CSA-FT6, the Canadian Standards Association (CSA) equivalent of the UL-910.

### Base Polymer

Polyvinyl chloride (PVC) is the predominate polymer used in plenum jacketing compositions that comprise chloropolymers. One or more other chlorine containing polymers can be blended with PVC. Polyvinylidene chloride provides additional chlorine and fire retardancy. Chlorinated polyethylene (CPE) provides additional chlorine and adds flexibility to the compound. CPVC is PVC that has been chlorinated via a free radical chlorination. The chlorine content can vary from greater than 56.7 wt % to as high as 74 wt %, although most commercial resins contain from 63 wt % to 69 wt % chlorine. When present, the other chlorine containing polymer or polymers can comprise up to about 25 wt %, typically up to about 20 wt %, more typically about 20 wt % of the base polymer.

PVC alone, i.e., without additives such as plasticizers, does not have the physical properties or flammability properties that are required for plenum cable jackets. The problems relating to physical properties are: a) lack of flexibility; b) thermal and oxidative discoloration under high temperature processing conditions and upon aging and; c) combustibility. As discussed below, various additives are added to alter the properties of the composition to make it useful as a plenum cable jacket.

### Plasticizers

Plasticizers, sometimes know as flexibilizers or flexibilizing agents, are added to PVC to increase flexibility. However, plasticizers are the single largest contributor to flammability in flexible PVC. Because of the stringent flame and smoke requirements, the choice of the plasticizer in the plenum jacket composition is critical.

Phosphate plasticizers have been used in plenum cable compositions. Triaryl phosphates are excellent flame retardant plasticizers, but generally generate too much smoke for use in plenum cables. Alky diphenyl phosphates and alkyl diaryl phosphates retain most of the flame retardant characteristics, but produce significantly less smoke. SANTICIZER® 2148 (Ferro, Cleveland, Ohio USA), an alky diaryl phosphate with very low volatility, is frequently used. Halogenated plasticizers include chlorinated plasticizers and brominated plasticizers. Chlorinated polyethylene (CPE) can be used as a plasticizer. Chlorinated polyethylene, prepared by chlorination of polyethylene, typically comprises about 22 wt % to 60 wt % chlorine. Brominated plasticizers offer slight plasticizing effects and their halogen content provides extra flame retardancy. Examples of brominated plasticizers include brominated di-octyl phosphate and a tetrabromopthalate ester (bis(2-ethylhexyl)tetrabromophthalate) sold under the trade names DP-45 (Great Lakes, West Lafayette, Ind. USA) and Uniplex FRP-45 (Unitex Chemical, Greensboro). Other plasticizers include: polymeric plasticizers, such as ethylene/acrylate/carbon monoxide terpolymers, for example ELVALOY® HP-441 (DuPont, Wilmington, Del. USA); fatty acid esters of pentaerythritol, such as HERCOFLEX 707 and HERCOFLEX 707A (Hercules, Wilmington Del. USA); alkyl trimellitates, such as PX-336, a trialkyl ester of 1,2,4-benzene tricarboxylic acid (trimellitic acid); and diesters of aliphatic diacids, such as dioctyl sebacate.

The compositions of the invention comprise about 20 phr to about 80 phr, typically about 30 phr to 75 phr, more typically about 40 phr to about 60 phr, or about 45 phr to about 55 phr, of a plasticizer or a mixture thereof, which typically includes a phosphate plasticizer and/or a halogenated plasticizer. As part of the total plasticizer, the compositions typically comprise about 10 phr to about 50 phr of a phosphate plasticizer, a halogenated plasticizer, or a combination thereof.

### Zeolites

Zeolites are natural or synthetic microporous crystalline inorganic compounds with three dimensional structures and generally contain silicon, aluminum, and oxygen in their framework and loosely held cations, water and/or other molecules in their pores. More particularly, zeolites are framework silicates consisting of interlocking tetrahedrons of SiO₄ and AlO₄. The SiO₄ and AlO₄ arrangement give a net negative charge to the pores that are responsible for holding the cations inside the pores and permits these cations to be readily exchanged with other cations.

Natural zeolites are aluminosilicates that can be represented by the general formula:

M_{a/n}O[(Al₂O₃)_{b}(SiO₂)_{c}].xH₂O

where M is a metal ion such as Na⁺, K⁺, Ca⁺², or Mg⁺²; n is valence of the metal ion M; a, b, c, and x are positive integers, where the ratio a:n=2, the ratio c:b is between 1:1 and 5:1. An example is the natural zeolite, natrolite, which has the structure:

Na₂O[(Al₂O₃)(SiO₂)₃].2H₂O.

The aluminosilicates structure is negatively charged and attracts the positive cations that reside within. When exposed to higher charged ions of a new element, zeolites will exchange the lower charged element contained within the zeolite for a higher charged element.

Examples of natural zeolites include: clinoptilolite (hydrated sodium, potassium, calcium aluminosilicate); analcime or analcite (hydrated sodium aluminum silicate); chabazite (hydrated calcium aluminum silicate); harmotome (hydrated barium potassium aluminum silicate); heulandite (hydrated sodium calcium aluminum silicate); laumontite (hydrated calcium aluminum silicate); mesolite (hydrated sodium calcium aluminum silicate); natrolite (hydrated sodium aluminum silicate); phillipsite (hydrated potassium sodium calcium aluminum silicate); scolecite (hydrated calcium aluminum silicate); stellerite (hydrated calcium aluminum silicate); stilbite (hydrated sodium calcium aluminum silicate); and thomsonite (hydrated sodium calcium aluminum silicate).

Synthetic zeolites can be made by slow crystallization of silica-alumina gels in the presence of an alkali and an organic template. The exact composition and structure of the zeolite formed depend on the composition of the reaction mixture, pH of the medium, operating temperature, reaction time, and the template used. Zeolite A, for example, can be made by mixing a source of alumina, such as sodium aluminate, and a source of silica, such as sodium silicate, in basic aqueous solution to give a gel. The gel is then heated to 70-300° C. to crystallize the zeolite. Zeolite A has a 3-dimensional pore structure with pores running perpendicular to each other in the x, y, and z planes. The pore diameter is defined by an eight member oxygen ring and is small at 4.2 Å. Zeolite A has a void volume fraction of 0.47, with a Si/Al ratio of 1.0.

Commercially available zeolites include several products of Nippon Chemical, sold as the “Zeostar’ zeolites, including: Zeostar CA-100P and Zeostar CA-110P; Zeostar CX-100P and Zeostar CX-110P; Zeostar KA-100P and Zeostar KA-110P; Zeostar NA-100P and NA-110P; and Zeostar NX-100P and Zeostar NX-110P; and the VALFOR® zeolites and ADVERA® zeolites, such as VALFOR® 100 sodium aluminosilicate hydrated type Na-A zeolite powder and ADVERA® 401/401P hydrated sodium zeolite A (PQ Corp., Valley Forge, Pa.).

Zeolites useful in the invention can either be a natural, synthetic, or a mixture thereof. The zeolite can be untreated or surface treated with such materials as higher fatty acids and their salts such as stearic acid, oleic acid, and salts of stearic acid and oleic acid, or salts of higher alkyl-, aryl-, or alkylaryl-sulfonic acids such as of dodecylbenzenesulfonic acid or the like. The zeolite can be calcined or uncalcined. Calcining can carried out at 200° C. to 700° C. for a period of 1-10 hours, typically at 300° C. to 500° C. for a period of 2-5 hours.

The zeolite can also be an ion-exchanged zeolite, that is, a natural or synthetic zeolite in which the alkali metal ions and/or alkaline earth ions of the aluminosilicate structure have been at least partially replaced by another metal ion. Typical ions that can be used include cations that contain an element selected from the group consisting of Al, V, Mo, Mn, Fe, Co, Ni, Cu, Sn, Zn, Cr, Ti, Zr, W, Sb, Bi, B, and P. The cation can contain more than one of these elements. Mixtures of these cations can also be used.

Ion-exchanged zeolites can be produced by stirring a mixture of the zeolite in an aqueous solution containing a water-soluble salt of the desired metal. In certain instances, it is preferable to stir the zeolite in a concentrated solution of sodium chloride in order to exchange sodium for the difficultly released potassium, calcium, and magnesium ions and then to effect further exchange of the sodium ions in a solution of the desired metal ion. The exchange can be carried out at about 20° C. to about 100° C., typically at about 40° C. to about 80° C.

It has been discovered that a zeolite, an ion-exchanged zeolite, or a mixture thereof can satisfactorily replace either part or all of the molybdenum compounds, particularly ammonium octamolybdate, in LS PVC plenum compositions. Typically, the composition will comprise from about 1 to about 3 parts, more typically about 1 part to about 2 parts, of zeolite ion-exchanged zeolite, or mixture thereof for each part of molybdenum compound replaced. Because these materials act as flame retardants as well as smoke suppressants, it is also possible to reduce the amount of flame retardant in the composition. Mixtures of molybdenum compounds, such as ammonium octamolybdate, and ion-exchanged zeolites, such as a zinc exchanged zeolite, in a ratio of about 1:2 weight to weight, molybdenum compound to zeolite, have been found to be particularly effect in reducing smoke, to, for example, 300 m²/Kg or less and 275 m²/Kg or less, in the cone calorimeter test, while maintaining the limiting oxygen index at 41 or higher.

Ion-exchanged zeolites in which the alkali metal ions and/or alkaline earth ions have been at least partially replaced by zinc ion have been found to be especially useful as a replacement for some or all the ammonium octamolybdate. Although useful, iron exchanged zeolites are not as effective as zinc exchanged zeolites in the formulations used in the examples, which are representative of compositions used to coat plenum cables. However, the specific effectiveness of the ion exchanged zeolite will depend, at least in part, on the specific stabilizers and co-additives used in the particular composition.

The composition comprises about 5 phr to about 35 phr, or about 8 phr to about 30 phr, or about 10 phr to about 25 phr, of the zeolite, ion-exchanged zeolite, or a mixture thereof.

### Other Smoke Suppressants

Typically a mixture of smoke suppressants are used to meet the requirements of LS PVC compositions. Borates, especially zinc borate, are commonly used. Borate derivatives act as both a flame and smoke retardant when used in conjunction with an active filler. Zinc borate, commonly used in conjunction with antimony trioxide, is commercially available as FIREBRAKE® ZB (U.S. Borax, Los Angeles, Calif. USA). Zinc hydroxystannate and zinc stannate are also used as smoke suppressants.

Although these smoke suppressants contribute to the overall performance, most producers have found that the addition of a molybdenum compound is critical to passing the smoke requirements of the Steiner Tunnel Test. The two most commonly molybdenum compounds used as smoke suppressants are MoO₃ and ammonium octamolybdate (AOM). MoO₃ imparts a blue gray color. AOM is water white and does not affect the final color of the LS PVC composition so AOM is typically the molybdenum compound of choice.

Zeolites and ion-exchanged zeolites act as smoke suppressants. Therefore, the amount of other smoke suppressants present in the composition can be reduced or the other smoke suppressants eliminated entirely when a zeolite, ion-exchanged zeolite, or a mixture thereof is present. In particular, as described above, zeolites and/or ion-exchanged zeolites can be used to replace molybdenum compounds, especially ammonium octamolybdate. The composition can comprise 0 to about 20, or 0 to about 10 phr, or 0 to about 5 phr, of a molybdenum compound or a mixture of molybdenum compounds. The composition can also comprise 0 to about 5 phr of smoke suppressants other than zeolites and/or ion-exchanged zeolites and molybdenum compounds, such as zinc borate.

### Flame Retardants

Antimony compounds, especially antimony trioxide act a synergist increasing the performance of the halogenated ingredients (PVC and other additives) to lower heat release rate and flame propagation. However, antimony contributes to smoke release and at certain levels can be antagonistic to phosphate plasticizers. The composition can comprise 0 to about 20 phr, or 0 to about 10 phr, of an antimony compound, such as antimony trioxide. Because zeolites and ion-exchanged zeolites act as flame retardants as well as smoke suppressants, the amount of flame retardant in the composition, such as antimony trioxide, can reduced when a zeolite, ion-exchanged zeolite, or a mixture thereof is present in the composition.

### Fillers

The composition comprises a filler or a mixture of fillers. Typical fillers are hydrated aluminum oxide (alumina trihydrate, Al₂O₃.3H₂O), magnesium hydroxide, metal carbonates, such as calcium carbonate and magnesium carbonate. These materials are active fillers, providing the normal benefits of a filler along with additional flame retardation upon thermal decomposition. Other fillers include magnesium oxide and electrical grade calcined kaolin clay. The composition comprises about 10 to about 100 phr of a filler or a mixture of fillers.

### Stabilizers

In order to prevent thermal and oxidative discoloration and brittleness due to the effects of heat and/or light, a stabilizer is added to the composition. Typical stabilizers are lead stabilizers, tin stabilizers, and epoxidized soy bean oil. Typical lead stabilizers are basic lead compounds such as tribasic lead sulfate, dibasic lead phosphite, or dibasic lead phosphite sulfite are used. To enhance the effect of these lead compounds, typically metal soaps such as neutral or basic lead stearate and/or calcium stearate are added. The composition typically comprises 2 to 20 parts of a stabilizer or a mixture of stabilizers.

For environmental reasons, lead compounds are being replaced with other materials. Calcium, zinc, and barium stearates, and mixtures thereof, are being used to replace lead compounds. However, the replacement of lead compounds with other materials is not a simple matter. Complete reformulation is often required. Zeolites and/or ion-exchanged zeolites are especially useful in for use in lead-free LS PVC based compositions, that is, in LS PVC based compositions that do not comprise a lead stabilizer or any other lead containing additive.

### Other Ingredients

Lubricants are also added to vinyl polymers to facilitate the extrusion or other melt processing of the structural articles produced. Examples of commonly used lubricants are: stearic acid and paraffin waxes. Antioxidants, such as 4,4′,4″-(1-methyl-1-propanyl-3-ylidene) tris (2-(1,1-dimethylethyl))-5-methyl phenol, can be added to prevent oxidation of the base polymer. Colorants, i.e., dyes and/or pigments, can be added to impart a color to the composition. A common white pigment is titanium dioxide.

### Preparation

In one embodiment, the invention is a method for the preparation of plenum cables that comprise a jacket comprising the composition of the invention jacketing a pair of twisted pairs of insulated copper wires or a fiber optic cable. The insulating material for the copper wire can be any insulating material customarily used in the preparation of plenum cables, such as polyethylene, fluorinated ethylene propylene copolymer (FEP), or a LS PVC based composition. The composition can be used as the insulating material, if desired.

Any method which provides uniform mixing of the ingredients can be used to prepare the compositions of this invention. A preferred procedure involves the steps of dry blending all of the ingredients to homogeneity followed by fluxing the dry blend at elevated temperatures and then extruding the melt blend, cooling and then dicing into cubed or pelletized form. Subsequently, the resulting pellets can then be used in a conventional extruder fitted with conductor insulation or jacketing die means to provide an insulated electrical conductor or jacketed cable. Methods of fabricating insulated wire and cable are well known in the art and are disclosed, for example, in Arroyo, U.S. Pat. No. 4,605,818, the disclosure which is herein incorporated by reference.

Alternatively, all the additives, without the base polymer, can be blended together as an additive package. Manufacturers of plenum cable prepare the composition by adding the additive package to the base polymer and extruding the resulting melt blend. Alternatively, all of the additives can be added to a small amount of base polymer, for example about 1 to about 20 parts, instead of 100 parts, to produce a master batch. Manufacturers of plenum cable prepare the composition by adding the master batch to the base polymer and extruding the resulting melt blend.

### INDUSTRIAL APPLICABILITY

A zeolite, either natural and/or synthetic, and/or an ion-exchanged zeolite, or a mixture thereof can satisfactorily replace either part or all of the molybdenum compound or compounds, particularly ammonium octamolybdate, in LS PVC based plenum compositions. Because the cost of these zeolites is only a fraction of the cost of the molybdenum compounds currently used in plenum compositions, this will dramatically reduce the cost of LS PVC based compositions.

The advantageous properties of this invention can be observed by reference to the following examples, which illustrate but do not limit the invention.

### EXAMPLES

### Glossary

Alkyl Diaryl Phosphate Plasticizer SANTICIZER® 2148 (Ferro, Cleveland, Ohio USA)
Aryl Phosphate Plasticizer REOFOS® 65 (Great Lakes, West Lafayette, Ind. USA)
Brominated Phthalate Ester DP-45 (Great Lakes, West Lafayette, Ind. USA)
Filler Calcium Carbonate
Natural zeolite Clinoptilolite (hydrated sodium, potassium, calcium aluminosilicate)
PVC Geon OxyVinyl240 PVC (PolyOne Corporation, Avon Lake, Ohio)
Zinc Borate FIREBRAKE® ZB (U.S. Borax, Los Angeles, Calif. USA)

Synthetic zeolites used in the compositions were Type A synthetic zeolites characterized by the following particle sizes, pore sizes, and moisture contents according to manufacturer's specification.

| | Size Range (μm) | <10 micron % | <20 micron % |
|---|---|---|---|
| Synthetic Zeolite 1 | 3-6 | not applicable | not applicable |
| Synthetic Zeolite 2 | 3-6 | >90 | >98 |
| Synthetic Zeolite 3 | 2-5 | >90 | >98 |
| Synthetic Zeolite 4 | 2-4 | >99 | 100 |

### Preparation of Test Samples

A two roll mill is used to mix the components of the composition. A 500 g batch is used.

PVC is weighed separately from the other components. Then the dry components are mixed with all the liquid components. PVC is first fluxed in the roll mill at about 204° C. (400° F.) of both rolls. After the PVC is fluxed, the mixture of the powders and liquids is added very slowly, so as not to loose the flux. After all the material is on the mill, the material is mixed for 10 min or until thorough mixing is achieved.

The material is then removed from the mill, cut into small pieces, and compression molded into test samples appropriate for the various flammability tests. Compression molding temperature is about 188° C. (370° F.). Pressouts are made by compression molding. Cone calorimeter plaques are made using 0.159 cm ( 1/16 in) shims, which are then cut into 10.16 cm×10.16 cm×0.159 cm (4×4× 1/16 in) plaques.

### Sample Evaluation

Heat release rate and other fire properties of materials and products can be determined on small samples with a cone calorimeter, which is a valuable small scale test for assessing the performance of various compositions. The cone calorimeter is standardized in the United States using ASTM E 1354 (Standard Method for Heat and Visible Smoke Release) and NFPA 271, and internationally as ISO 5660. Cone calorimeter data has been found to correlate well with data obtained from the Steiner Tunnel Teat (UL-910) or ASTM E84. See, for example, M. M. Khanm, R. G. Bill Jr., and R. L. Alpert, Fire and Materials, 30, 65-76 (2005); M. M. Hirschler, J. Fire Sci., 9, 183-222 (1991), and J. D. Innes and A. W. Cox, J. Fire Sci., 15, 227-239 (1997).

A cone-shaped heater is used to expose a 100×100-mm square sample of material to a radiant heat flux of 50 kW/m². Measured properties include time to ignition, heat release rate, total heat released, effective heat of combustion, mass loss, smoke production, specific extinction area, and critical flux for ignition. A specific extinction area (SEA) for the smoke value below about 300 m²/kg in cone-calorimeter is considered to be approximately equivalent an optical density below 0.5 in the Steiner Tunnel Test.

Limiting oxygen index was determined by ASTM D2863. Limiting oxygen index is the minimum concentration of oxygen that will just support flaming combustion in a flowing mixture of oxygen and nitrogen. A specimen is positioned vertically in a transparent test column and a mixture of oxygen and nitrogen is forced upward through the column. The specimen is ignited at the top. The oxygen concentration is adjusted until the specimen just supports combustion. The concentration reported is the volume percent of oxygen at which the specimen just supports combustion.

### Example 1

This example shows clinoptilolite, a natural zeolite, can replace ammonium octamolybdate is a PVC composition. Zeolite reduced smoke relative to a calcium carbonate filler. In addition, zeolite reduced the Peak Heat Release Rate and increased the Limiting Oxygen Index relative to both calcium carbonate, a common filler in PVC compositions, and ammonium octamolybdate, indicating that it is also effective as a flame retardant.

TABLE 1

| | Example | | |
|---|---|---|---|
| Ingredient | #1-1 | #1-2 | #1-3 |
| PVC Powder | 100 | 100 | 100 |
| Magnesium Hydroxide | 40 | 40 | 40 |
| Brominated Phthalate Ester | 40 | 40 | 40 |
| Alkyl Diaryl Phosphate Plasticizer | — | — | — |
| Lead Stabilizer | 7 | 7 | 7 |
| Filler | 20 | | — |
| Ammonium Octamolybdate | — | 20 | — |
| Natural Zeolite | — | — | 20 |
| Limiting Oxygen Index | 45 | 46 | 47 |
| Cone Calorimeter Data | | | |
| Smoke (m²/Kg) | 394.8 | 170.2 | 267.2 |
| Total Ignition Time (sec) | 26.9 | 33.4 | 26.3 |
| Peak Heat Release Rate (KW/m²) | 153.7 | 128.3 | 86.4 |
| Average Mass Loss Rate (g/m²-sec) | 14.7 | 13.9 | 13.9 |
| Total Heat Release (MJ/m²) | 14.4 | 7.2 | 0.9 |
| Effective Heat of Combustion (MJ/Kg) | 8.49 | 6.47 | 2.6 |

### Example 2

Example 2 compares the performance of various zeolites to compositions containing high levels of ammonium octamolybdate. Example #2-1 is a control, which is similar to Composition No. 1 disclosed in Linsky, U.S. Pat. No. 5,886,072, the entire disclosure of which is incorporated herein by reference. The composition disclosed by Linsky is reported to pass the Steiner Tunnel Test.

TABLE 2

| | Example | | | |
|---|---|---|---|---|
| Ingredient | #2-1 | #2-2 | #2-3 | #2-4 |
| PVC | 100 | 100 | 100 | 100 |
| Polymeric Plasticizer | 33 | 33 | 33 | 33 |
| Filler | 5 | 5 | 5 | 5 |
| Alumina Trihydrate | 70 | 70 | 70 | 70 |
| Lead Stabilizer | 6 | 6 | 6 | 6 |
| Antimony Trioxide | 5 | 5 | 5 | 5 |
| Brominated Phthalate | 10 | 10 | 10 | 10 |
| Alkyl Diaryl Phosphate Plasticizer | 5 | 5 | 5 | 5 |
| Zinc Borate | 2 | 2 | 2 | 2 |
| Ammonium Octamolybdate | 10 | 5 | 5 | 5 |
| Natural Zeolite | — | 5 | — | — |
| Synthetic Zeolite 1 | — | — | 5 | — |
| Synthetic Zeolite 2 | — | — | — | 5 |
| Synthetic Zeolite 3 | — | — | — | — |
| Limiting Oxygen Index | 46 | 47 | 48 | 46 |
| Cone Calorimeter | | | | |
| Smoke (m²/kg) | 175.7 | 213.1 | 237.1 | 224.1 |
| Total Ignition Time (sec) | 105.1 | 94.8 | 93.9 | 85 |
| Peak Heat Release Rate (KW/m²) | 115.1 | 153.1 | 148.7 | 162.9 |
| Average Mass Loss Rate (g/m²-sec) | 12.5 | 13.8 | 14 | 14.5 |
| Total Heat Release (MJ/m²) | 13.3 | 18.1 | 16 | 16.8 |
| Effective Heat of Combustion (MJ/Kg) | 8.1 | 9 | 8.8 | 9.2 |
| | Example | | | |
| Ingredient | #2-5 | #2-6 | #2-7 | #2-8 |
| PVC | 100 | 100 | 100 | 100 |
| Polymeric Plasticizer | 33 | 33 | 33 | 33 |
| Filler | 5 | 5 | 5 | 5 |
| Alumina Trihydrate | 70 | 70 | 70 | 70 |
| Lead Stabilizer | 6 | 6 | 6 | 6 |
| Antimony Trioxide | 5 | 5 | 5 | 5 |
| Brominated Phthalate | 10 | 10 | 10 | 10 |
| Alkyl Diaryl Phosphate Plasticizer | 5 | 5 | 5 | 5 |
| Zinc Borate | 2 | 2 | 2 | 2 |
| Ammonium Octamolybdate | 5 | — | — | — |
| Natural Zeolite | — | 10 | — | — |
| Synthetic Zeolite 1 | — | — | 10 | — |
| Synthetic Zeolite 2 | — | — | — | 10 |
| Synthetic Zeolite 3 | 5 | — | — | — |
| Limiting Oxygen Index | 46 | 47 | 47 | 44 |
| Cone Calorimeter | | | | |
| Smoke (m²/kg) | 214.9 | 311.7 | 312.2 | 335.8 |
| Total Ignition Time (sec) | 92.2 | 97.9 | 101.4 | 98.9 |
| Peak Heat Release Rate (KW/m²) | 153.3 | 136.4 | 133.2 | 135.6 |
| Average Mass Loss Rate (g/m²-sec) | 13.7 | 12.5 | 11.8 | 11.8 |
| Total Heat Release (MJ/m²) | 17.3 | 18.6 | 19.9 | 19.9 |
| Effective Heat of Combustion (MJ/Kg) | 9.1 | 9.5 | 10.2 | 10.3 |

In these examples, one phr of ammonium octamolybdate was replaced with one phr of zeolite. In Examples #2-2, #2-3, #2-4, and #2-5, half of the ammonium octamolybdate was replaced with zeolite. In Examples #2-6, #2-7, and #2-8, all of the ammonium octamolybdate was replaced with zeolite. The results show that zeolites possess excellent smoke suppression capabilities as well as superior heat rates, indicating their effectiveness as flame retardants and smoke suppressant additives.

### Example 3

TABLE 3

| | Example | | | |
|---|---|---|---|---|
| Ingredient | #3-1 | #3-2 | #3-3 | #3-4 |
| PVC | 100 | 100 | 100 | 100 |
| Polymeric Plasticizer | 33 | 33 | 33 | 33 |
| Filler | 5 | 5 | 5 | 5 |
| Alumina Trihydrate | 70 | 70 | 70 | 70 |
| Lead Stabilizer | 6 | 6 | 6 | 6 |
| Antimony Trioxide | 5 | 5 | 5 | 5 |
| Brominated Phthalate | 10 | 10 | 10 | 10 |
| Alkyl Diaryl Phosphate Plasticizer | 5 | 5 | 5 | 5 |
| Zinc Borate | 2 | 2 | 2 | 2 |
| Ammonium Octamolybdate | 10 | 5 | 5 | 5 |
| Natural Zeolite | — | 10 | — | — |
| Synthetic Zeolite 1 | — | — | 10 | — |
| Synthetic Zeolite 2 | — | — | — | 10 |
| Synthetic Zeolite 3 | — | — | — | — |
| Limiting Oxygen Index | 46 | 46 | 46 | 46 |
| Cone Calorimeter Data | | | | |
| Smoke (m²/Kg) | 153 | 179.1 | 191 | 192.9 |
| Total Ignition Time (sec) | 90.2 | 92 | 94.5 | 93.5 |
| Peak Heat Release Rate (KW/m²) | 103.7 | 99.9 | 95.5 | 95.6 |
| Average Mass Loss Rate (g/m²-sec) | 13.9 | 14.4 | 13.6 | 13.9 |
| Total Heat Release (MJ/m²) | 10.5 | 9.4 | 10.7 | 9.7 |
| Effective Heat of Combustion (MJ/Kg) | 5.3 | 5.2 | 5.9 | 5.6 |
| | Example | | | |
| Ingredient | #3-5 | #3-6 | #3-7 | #3-8 |
| PVC | 100 | 100 | 100 | 100 |
| Polymeric Plasticizer | 33 | 33 | 33 | 33 |
| Filler | 5 | 5 | 5 | 5 |
| Alumina Trihydrate | 70 | 70 | 70 | 70 |
| Lead Stabilizer | 6 | 6 | 6 | 6 |
| Antimony Trioxide | 5 | 5 | 5 | 5 |
| Brominated Phthalate | 10 | 10 | 10 | 10 |
| Alkyl Diaryl Phosphate Plasticizer | 5 | 5 | 5 | 5 |
| Zinc Borate | 2 | 2 | 2 | 2 |
| Ammonium Octamolybdate | — | — | — | — |
| Natural Zeolite | 20 | — | — | — |
| Synthetic Zeolite 1 | — | 20 | — | — |
| Synthetic Zeolite 2 | — | — | 20 | — |
| Synthetic Zeolite 3 | — | — | — | 20 |
| Limiting Oxygen Index | 46 | 45 | 44 | 43 |
| Cone Calorimeter Data | | | | |
| Smoke (m²/Kg) | 256.2 | 281.1 | 272.2 | 277.9 |
| Total Ignition Time (sec) | 96.2 | 100.6 | 112.1 | 107.3 |
| Peak Heat Release Rate (KW/m²) | 88.6 | 86.3 | 82.8 | 77.7 |
| Average Mass Loss Rate (g/m²-sec) | 12.5 | 12.1 | 12.1 | 12.1 |
| Total Heat Release (MJ/m²) | 11.2 | 11.1 | 10.9 | 10.1 |
| Effective Heat of Combustion (MJ/Kg) | 6.1 | 6.2 | 6 | 5.6 |

In these examples, one phr of ammonium octamolybdate was replaced with two phr of zeolite. In Examples #3-2, #3-3 and #3-4, half of the ammonium octamolybdate was replaced with zeolite. In Examples, #3-5, #3-6, #3-7, and #3-8, all of the ammonium octamolybdate was replaced with zeolite. The results again show that zeolites possess excellent smoke suppression capabilities as well as superior heat rates, indicating their effectiveness as flame retardants and smoke suppressant additives.

### Example 4

Examples #4-2 and #4-3 show the effect of partial replacement of antimony trioxide with zeolite.

Example #4-4 shows outstanding performance by the addition of 2 phr of synthetic zeolite to a composition comprising ammonium octamolybdate. The Limiting Oxygen Index increased to 48 and the smoke decreased to 85.5 m²/Kg, indicating that the zeolite is acting as both a flame retardant and a smoke suppressant.

TABLE 4

| | Example | | | |
|---|---|---|---|---|
| Ingredient | #4-1 | #4-2 | #4-3 | #4-4 |
| PVC | 100 | 100 | 100 | 100 |
| Polymeric Plasticizer | 33 | 33 | 33 | 33 |
| Filler | 5 | 5 | 5 | 5 |
| Alumina Trihydrate | 70 | 70 | 70 | 70 |
| Lead Stabilizer | 6 | 6 | 6 | 6 |
| Brominated Phthalate | 10 | 10 | 10 | 10 |
| Alkyl Diaryl Phosphate Plasticizer | 5 | 5 | 5 | 5 |
| Zinc Borate | 2 | 2 | 2 | 2 |
| Antimony Trioxide | 5 | 2.5 | 2.5 | 2.5 |
| Ammonium Octamolybdate | 10 | 10 | 5 | 10 |
| Natural Zeolite | — | — | 2.5 | — |
| Synthetic Zeolite 1 | — | 2.5 | — | 2 |
| Limiting Oxygen Index | 46 | 45 | 45 | 48 |
| Cone Calorimeter Data | | | | |
| Smoke (m²/Kg) | 120 | 141 | 128 | 85.5 |
| Total Ignition Time (sec) | 98.5 | 84.6 | 88 | 111 |
| Peak Heat Release Rate (KW/m²) | 160 | 135 | 140 | 118 |
| Average Mass Loss Rate (g/m²-sec) | 14.7 | 14.1 | 14.2 | 12.5 |
| Total Heat Release (MJ/m²) | 16.7 | 15 | 15 | 15 |
| Effective Heat of Combustion (MJ/Kg) | 8.8 | 8.2 | 8.4 | 8.2 |

### Example 5

This example compares performance of synthetic zeolite to natural zeolite.

TABLE 5

| | Example | | | |
|---|---|---|---|---|
| Ingredient | #5-1 | #5-2 | #5-3 | #5-4 |
| PVC | 100 | 100 | 100 | 100 |
| Polymeric Plasticizer | 33 | 33 | 33 | 33 |
| Filler | 5 | 5 | 5 | 5 |
| Alumina Trihydrate | 70 | 70 | 70 | 70 |
| Lead Stabilizer | 6 | 6 | 6 | 6 |
| Brominated Phthalate | 10 | 10 | 10 | 10 |
| Alkyl Diaryl Phosphate Plasticizer | 5 | 5 | 5 | 5 |
| Zinc Borate | 2 | 2 | 0 | 0 |
| Antimony Trioxide | 5 | 5 | 5 | 5 |
| Ammonium Octamolybdate | 10 | 5 | 5 | 5 |
| Natural Zeolite | 0 | 10 | 10 | 12 |
| Synthetic Zeolite 1 | 0 | 0 | 0 | 0 |
| Synthetic Zeolite 2 | 0 | 0 | 0 | 0 |
| Limiting Oxygen Index | 46 | 47 | 46 | 47 |
| Cone Calorimeter Data | | | | |
| Smoke (m²/Kg) | 120 | 157.4 | 177 | 152 |
| Total Ignition Time (sec) | 98.5 | 92 | 98.4 | 104.6 |
| Peak Heat Release Rate (KW/m²) | 160 | 151 | 136.5 | 131.6 |
| Average Mass Loss Rate (g/m²-sec) | 14.7 | 13.9 | 12.5 | 12 |
| Total Heat Release (MJ/m²) | 16.7 | 15.9 | 17.3 | 18.3 |
| Effective Heat of Combustion (MJ/Kg) | 8.8 | 8.6 | 9.2 | 9.5 |

| | Example | | |
|---|---|---|---|
| Ingredient | #5-5 | #5-6 | #5-7 |
| PVC | 100 | 100 | 100 |
| Polymeric Plasticizer | 33 | 33 | 33 |
| Filler | 5 | 5 | 5 |
| Alumina Trihydrate | 70 | 70 | 70 |
| Lead Stabilizer | 6 | 6 | 6 |
| Antimony Trioxide | 5 | 5 | 5 |
| Brominated Phthalate | 10 | 10 | 10 |
| Alkyl Diaryl Phosphate Plasticizer | 5 | 5 | 5 |
| Ammonium Octamolybdate | 5 | 5 | 5 |
| Zinc Borate | 2 | — | — |
| Synthetic Zeolite 1 | 10 | 10 | 12 |
| Limiting Oxygen Index | 46 | 46 | 45 |
| Cone Calorimeter Data | | | |
| Smoke (m²/Kg) | 173 | 222 | 198 |
| Total Ignition Time (sec) | 96.9 | 97.2 | 98.1 |
| Peak Heat Release Rate (KW/m²) | 136.1 | 134 | 137.5 |
| Average Mass Loss Rate (g/m²-sec) | 13.2 | 12.7 | 12.9 |
| Total Heat Release (MJ/m²) | 15 | 13.6 | 15.7 |
| Effective Heat of Combustion (MJ/Kg) | 8.4 | 8.4 | 9 |

### Example 6

This example demonstrates that the expensive alkyl diaryl phosphate plasticizer SANTICIZER® 2148 can be replaced with less expensive aryl phosphate, especially when a combination of zeolite and ammonium octamolybdate is used. In addition, a more volatile triaryl phosphate, such as REOFOS® 35, would be more beneficial for reduced smoke properties and would offer further advantages.

TABLE 6

| | Example | | | |
|---|---|---|---|---|
| Ingredient | #6-1 | #6-2 | #6-3 | #6-4 |
| PVC | 100 | 100 | 100 | 100 |
| Polymeric Plasticizer | 33 | 33 | 33 | 33 |
| Calcined Clay | 5 | 5 | 5 | 5 |
| Alumina Trihydrate | 70 | 70 | 70 | 70 |
| Lead Stabilizer | 6 | 6 | 6 | 6 |
| Stearic Acid | 0.25 | 0.25 | 0.25 | 0.25 |
| Antimony Oxide | 5 | 5 | 5 | 5 |
| Brominated Phthalate | 10 | 10 | 10 | 10 |
| Zinc Borate | 2 | 2 | 2 | 2 |
| Alkyl Diaryl Phosphate Plasticizer | 5 | — | 5 | — |
| Aryl Phosphate Plasticizer | — | 5 | — | 5 |
| Ammonium Octamolybdate | 10 | 10 | 5 | 5 |
| Natural Zeolite | — | — | 5 | 5 |
| Limiting Oxygen Index | 46 | 48 | 47 | 48 |
| Cone Calorimeter Data | | | | |
| Smoke (m²/Kg) | 175.7 | 208.2 | 213.1 | 220 |
| Heat Release Rate 60 sec Average | NC | NC | 103.5 | 100.6 |
| Total Ignition Time (sec) | 105.1 | 104.7 | 94.8 | 93.8 |
| Peak Heat Release Rate (KW/m²) | 115.1 | 107.4 | 153.1 | 130 |
| Average Mass Loss Rate | 12.5 | 9.8 | 13.8 | 10.8 |
| (g/m²-sec) | | | | |
| Total Heat Release (MJ/m²) | 13.3 | 14.7 | 18.1 | 18 |
| Effective Heat of Combustion | 8.1 | 8.42 | 9 | 8.5 |
| (MJ/Kg) | | | | |

### Example 7

This example demonstrates that ion-exchanged zeolite in which the alkali metal ions and/or alkaline earth ions have been at least partially replaced by zinc ion have been found to be especially useful as a replacement for some or all the antimony compounds, especially ammonium octamolybdate. The composition is a lead-free composition.

The zinc exchanged zeolite is prepared by stirring the unexchanged zeolite in aqueous zinc chloride. The process uses about 15-20 ml of water per gram of unexchanged zeolite and 1 part of zinc chloride per 2.6 parts of unexchanged zeolite. The unexchanged zeolite is stirred in the aqueous zinc chloride for 20 hr. Then the resulting exchanged zeolite is filtered under vacuum, dried and pulverized. The amount of exchange can be increased by following the first exchange by a second exchange in which the exchanged zeolite from the first exchange is stirred for 2-8 hr in an more concentrated zinc chloride solution (50% more) and then filtered and dried.

TABLE 7

| | Example | | | | |
|---|---|---|---|---|---|
| Ingredient | Control | #7-1 | #7-2 | #7-3 | #7-4 |
| PVC Powder | 100 | 100 | 100 | 100 | 100 |
| Alumina Trihydrate | 70 | 70 | 70 | 70 | 70 |
| Alkyl Diaryl Phosphate Plasticizer | 15 | 15 | 15 | 15 | 15 |
| Other Plasticizers | 32.5 | 32.5 | 32.5 | 32.5 | 32.5 |
| Mixed Metal Stabilizer | 6 | 6 | 6 | 6 | 6 |
| Lubricants | 0.3 | 0.3 | 0.3 | 0.3 | 0.3 |
| Antimony Oxide | 3 | 3 | 3 | 3 | 3 |
| Calcined Clay | 5 | 5 | 5 | 5 | 5 |
| Ammonium Octamolybdate | 10 | — | 5 | 5 | — |
| Synthetic Type A Zeolite | — | — | 10 | — | — |
| Natural Zeolite | — | — | — | 10 | — |
| Zinc Exchanged Type A Zeolite | — | — | — | — | 10 |
| Total | 241.8 | 231.8 | 246.8 | 246.8 | 246.8 |
| Limiting Oxygen Index | 42 | 39 | 40 | 41 | 38 |
| Cone Calorimeter Data | | | | | |
| Smoke (m²/Kg) | 352 | 534 | 505 | 457 | 352 |
| HHR 60 sec Ave. (Kw/m²) | 85 | 123 | 118 | 111 | 123 |
| Total Ignition Time (sec) | 111 | 92 | 87 | 104 | 90 |
| Peak Heat Release Rate (Kw/m²) | 157 | 168 | 155 | 161 | 176 |
| Average Mass Loss Rate (g/m²-sec) | 10.2 | 10.5 | 9.8 | 10.9 | 10.7 |
| Total Heat Release (MJ/m²) | 23.6 | 20.9 | 21.8 | 21.4 | 23.7 |
| Effective Heat of Combustion (MJ/Kg) | 11.8 | 11.2 | 12.0 | 11.4 | 13.2 |
| Properties | | | | | |
| Elongation (%) | 235 | 48 | 96 | 187 | 227 |
| Specific Gravity | 1.57 | 1.55 | 1.54 | 1.55 | 1.53 |

| | Examples | | | |
|---|---|---|---|---|
| Ingredient | #7-5 | #7-6 | #7-7 | #7-8 |
| PVC Powder | 100 | 100 | 100 | 100 |
| Alumina Trihydrate | 70 | 70 | 70 | 70 |
| Alkyl Diaryl Phosphate Plasticizer | 15 | 15 | 21 | 21 |
| Other Plasticizers | 32.5 | 32.5 | 26 | 26 |
| Mixed Metal Stabilizer | 6 | 6 | 6 | 6 |
| Lubricants | 0.3 | 0.3 | 0.3 | 0.3 |
| Antimony Oxide | 3 | 3 | 3 | 3 |
| Calcined Clay | 5 | 5 | 5 | 5 |
| Ammonium Octamolybdate | 5 | — | — | 5 |
| Synthetic Type A Zeolite | — | — | — | — |
| Natural Zeolite | — | — | — | — |
| Zinc Exchanged Type A Zeolite | 10 | 20 | 20 | 10 |
| Total | 246.8 | 251.8 | 251.3 | 246.3 |
| Limiting Oxygen Index | 42 | 39 | 36 | 42 |
| Cone Calorimeter Data | | | | |
| Smoke (m²/Kg) | 328 | 679 | 681 | 267 |
| HHR 60 sec Ave. (Kw/m²) | 107 | 134 | 145 | 91 |
| Total Ignition Time (sec) | 111 | 66 | 65 | 120 |
| Peak Heat Release Rate (Kw/m²) | 175 | 152 | 171 | 171 |
| Average Mass Loss Rate (g/m²-sec) | 9.6 | 10.8 | 11.2 | 10.5 |
| Total Heat Release (MJ/m²) | 25.0 | 22.5 | 23.3 | 21.4 |
| Effective Heat of Combustion (MJ/Kg) | 12.9 | 12.2 | 12.6 | 12.3 |
| Properties | | | | |
| Elongation (%) | 217 | 112 | 231 | 237 |
| Specific Gravity | 1.51 | 1.53 | 1.54 | 1.53 |

What is claimed is:

1. A composition comprising a 100 parts of chlorinated base polymer and greater than 2 parts of (a) a zeolite, (b) an ion-exchanged zeolite in which at least part of the cations in the ion-exchanged zeolite contain an element selected from the group consisting of Al, V, Mo, Mn, Fe, Co, Ni, Cu, Sn, Zn, Cr, Ti, Zr, W, Sb, Bi, B, and P, or (c) a mixture thereof, in which the composition has a limiting oxygen index of 43 or higher and a smoke value of less than 300 m²/Kg in a cone calorimeter test.

2. The composition of claim 1 in which the composition comprises about 5 to about 35 parts of the zeolite or the mixture of zeolites.

3. The composition of claim 1 in which the composition has a limiting oxygen index of 46 or higher and a smoke value of less than 250 m²/Kg in the cone calorimeter test

4. The composition of claim 1 in which the composition is lead-free.

5. A composition comprising:
(a) 100 parts of a base polymer selected from the group consisting of polyvinyl chloride and mixtures of polyvinyl chloride and chlorinated polyvinyl chloride in which the chlorinated polyvinyl chloride comprises 25 wt % of less of the mixture of the polyvinyl chloride and the chlorinated polyvinyl chloride;
(b) 20 to 60 parts of a plasticizer, a brominated phthalate, a phosphate plasticizer, or a mixture thereof;
(c) 2 to 20 parts of a thermal stabilizer or a mixture of thermal stabilizers;
(d) 10 to 100 parts of a metal hydroxide or mixture of metal hydroxides;
(e) 0 to 20 parts of a molybdenum compound or a mixture of molybdenum compounds;
(f) 5 to 35 parts of a zeolite or mixture of zeolites, an ion-exchanged zeolite or a mixture of ion-exchanged zeolites, or a mixture thereof;
wherein:
the composition has a limiting oxygen index of 43 or higher,
the composition has a smoke value of less than 300 m²/Kg in the cone calorimeter test, and
at least part of the cations in the ion-exchanged zeolite contain an element selected from the group consisting of Al, V, Mo, Mn, Fe, Co, Ni, Cu, Sn, Zn, Cr, Ti, Zr, W, Sb, Bi, B and P.

6. The composition of claim 5 in which the polymer is polyvinyl chloride.

7. The composition of claim 5 in which the composition has a limiting oxygen index of 44 or higher.

8. The composition of claim 5 in which the composition has a limiting oxygen index of 45 or higher.

9. The composition of claim 5 in which the composition has a limiting oxygen index of 46 or higher.

10. The composition of claim 5 in which the composition has a smoke value of less than about 250 m²/Kg in the cone calorimeter test.

11. The composition of claim 5 in which the composition has a smoke value of less than about 210 m²/Kg in the cone calorimeter test.

12. The composition of claim 5 in which the composition comprises 0 to about 10 parts of a molybdenum compound or a mixture of molybdenum compounds.

13. The composition of claim 5 in which the composition comprises 0 to about 5 parts of a molybdenum compound or a mixture of molybdenum compounds.

14. The composition of claim 5 in which the composition is lead free.

15. The composition of claim 1 in which the composition contains 0 parts of a molybdenum compound or a mixture of molybdenum compounds.

16. The composition of claim 1 in which the zeolite is a natural zeolite.

17. The composition of claim 1 in which the zeolite is a synthetic zeolite.

18. The composition of claim 1 in which the zeolite is an ion-exchanged zeolite.

19. The composition of claim 18 in which the cation is the zinc cation.

20. A plenum cable comprising a jacket of the composition of claim 1 enclosing either (a) at least one twisted pair of insulated copper wires or (b) at least one fiber optic cable.

21. A coaxial cable construction comprising a jacket of the composition of claim 1 enclosing a coaxial cable.

22. A method for preparing a plenum cable, the method comprising extruding the composition of claim 1 over (a) at least one twisted pair of insulated copper wires or (b) at least one fiber optic cable.

23. A method for coaxial cable construction, the method comprising extruding the composition of claim 1 over a coaxial cable.

24. A master batch comprising:
(a) 20 parts of a base polymer selected from the group consisting of polyvinyl chloride and mixtures of polyvinyl chloride and chlorinated polyvinyl chloride in which the chlorinated polyvinyl chloride comprises 25 wt % of less of the mixture of the polyvinyl chloride and the chlorinated polyvinyl chloride;
(b) 20 to 60 parts of a plasticizer, a brominated phthalate, a phosphate plasticizer, or a mixture thereof;
(c) 2 to 20 parts of a thermal stabilizer or a mixture of thermal stabilizers;
(d) 10 to 100 parts of a metal hydroxide or mixture of metal hydroxides;
(e) 0 to 20 parts of a molybdenum compound or a mixture of molybdenum compounds;
(f) 5 to 35 parts of a zeolite or mixture of zeolites, an ion-exchanged zeolite or a mixture of ion-exchanged zeolites, or a mixture thereof.

25. The composition of claim 24 in which the composition comprises 0 to about 5 parts of a molybdenum compound or a mixture of molybdenum compounds.

26. The composition of claim 24 in which the composition is lead free.

27. A master batch comprising:
(a) 20 parts of a base polymer selected from the group consisting of polyvinyl chloride and mixtures of polyvinyl chloride and chlorinated polyvinyl chloride in which the chlorinated polyvinyl chloride comprises 25 wt % of less of the mixture of the polyvinyl chloride and the chlorinated polyvinyl chloride;
(b) 20 to 60 parts of a plasticizer, a brominated phthalate, a phosphate plasticizer, or a mixture thereof;
(c) 2 to 20 parts of a thermal stabilizer or a mixture of thermal stabilizers;
(d) 10 to 100 parts of a metal hydroxide or mixture of metal hydroxides;
(e) 0 to 20 parts of a molybdenum compound or a mixture of molybdenum compounds;
(f) 5 to 35 parts of a zeolite or mixture of zeolites, an ion-exchanged zeolite or a mixture of ion-exchanged zeolites, or a mixture thereof;
wherein:
at least part of the cations in the ion-exchanged zeolite contain an element selected from the group consisting of Al, V, Mo, Mn, Fe, Co, Ni, Cu, Sn, Zn, Cr, Ti, Zr, W, Sb, Bi, B and P.

28. The master batch of claim 27 in which the polymer is polyvinyl chloride.

29. The master batch of claim 27 in which the composition comprises 0 to about 10 parts of a molybdenum compound or a mixture of molybdenum compounds.

30. The master batch claim 27 in which the composition comprises 0 to about 5 parts of a molybdenum compound or a mixture of molybdenum compounds.

31. The master batch of claim 27 in which the composition is lead free.

32. The master batch of claim 27 in which the composition contains 0 parts of a molybdenum compound or a mixture of molybdenum compounds.

33. The master batch of claim 27 in which the zeolite is a natural zeolite.

34. The master batch of claim 27 in which the zeolite is a synthetic zeolite.

35. The master batch of claim 27 in which the zeolite is an ion-exchanged zeolite.

36. The master batch of claim 35 in which the cation is the zinc cation.

37. A composition comprising:
(a) 100 parts of a base polymer selected from the group consisting of polyvinyl chloride and mixtures of polyvinyl chloride and chlorinated polyvinyl chloride in which the chlorinated polyvinyl chloride comprises 25 wt % of less of the mixture of the polyvinyl chloride and the chlorinated polyvinyl chloride;
(b) 20 to 60 parts of a plasticizer, a brominated phthalate, a phosphate plasticizer, or a mixture thereof;
(c) 2 to 20 parts of a thermal stabilizer or a mixture of thermal stabilizers;
(d) 10 to 100 parts of a metal hydroxide or mixture of metal hydroxides;
(e) 2 to 10 parts of a molybdenum compound or a mixture of molybdenum compounds;
(f) 5 to 35 parts of an ion-exchanged zeolite or a mixture of ion-exchanged zeolites, or a mixture thereof;
wherein:
the composition has a limiting oxygen index of 41 or higher,
the composition has a smoke value of 300 m²/Kg or less in a cone calorimeter test, and
at least part of the cations in the ion-exchanged zeolite contain an element selected from the group consisting of Al, V, Mo, Mn, Fe, Co, Ni, Cu, Sn, Zn, Cr, Ti, Zr, W, Sb, Bi, B, and P.

38. The composition of claim 36 in which the cation is the zinc cation.

39. The composition of claim 37 in which the molybdenum compound is ammonium octamolybdate.

40. The composition of claim 36 in which the composition has a smoke value of 275 m²/Kg or less in the cone calorimeter test.
